(19) United States
(12) Patent Application Publication
(10) Pub. No.: US 2010/0205355 A1
(43) Pub. Date: Aug. 12, 2010

(54) MULTIPLEXING SECURE DIGITAL MEMORY

(75) Inventor: Victor MOSKALIK, Pointe-Claire (CA)

Correspondence Address: FREEDMAN & ASSOCIATES, 55 Murray Street, Suite 230, Ottawa, ON, K1N 5M3, CA

(73) Assignee: MEMORY EXPERTS INTERNATIONAL INC., Montreal (CA)

(21) Appl. No.: 12/695,503

(22) Filed: Jan. 28, 2010

Related U.S. Application Data
(60) Provisional application No. 61/151,638, filed on Feb. 11, 2009.

(51) Int. Cl. G06F 12/02; G06F 12/08

(52) U.S. Cl. 711/103; 711/114; 711/E12.008; 711/E12.019

(57) ABSTRACT

A method of storing data within a plurality of memory devices is disclosed. Each memory device of the plurality of memory devices comprises flash memory, and supports a first data transfer rate, A. Data is provided from a data interface to a multiplexer using a second data transfer rate, B, which is faster than the data transfer rate, A. Using the multiplexer, the data is divided into N data portions. Each one of the N data portions is provided to a different memory device of the plurality of memory devices using a third data transfer rate B/N, wherein B/N≦A. The N data portions are stored in parallel, each within a respective different memory device of the plurality of memory devices.

### FIELD OF THE INVENTION

The invention relates to portable secure digital memory and more particularly to multiplexing secure digital memory.

### BACKGROUND OF THE INVENTION

A USB flash drive, more commonly known as a memory stick, is a NAND-type flash memory data storage device integrated with a USB (universal serial bus) interface. USB flash drives are typically removable and rewritable, and supported by a wide range of portable and fixed electronic devices such as laptops, personal data analysers (PDAs), personal computers, etc. They are more compact, faster, hold much more data, have a more durable design, and are more reliable for lack of moving parts than previous removable media such as floppy discs, CD-ROM, and DVD-ROM. Storage capacities typically today range from 512 MB to 32 GB with steady improvements in size and price per gigabyte. Some allow 1 million write or erase cycles and have 10-year data retention, and are connected by USB 1.1 or USB 2.0 standard interfaces.

Additionally, these types of drives use the USB mass storage standard supported natively by modern operating systems such as Windows, Mac OS X, Linux, and other Unix-like systems. USB drives with USB 2.0 support can also be faster than an optical disc drive, while storing a larger amount of data in a much smaller space. Furthermore, their portability and optional embedding of biometric sensors and/or other authetication transducers for validation of user, coupled with an embedded processor for executing firmware, have made USB flash drives a common security device for storing encrypted data, security credentials, and other data relating to security, encryption, decryption and the user.

USB memory card readers are also available, whereby rather than being built-in, the memory is a removable flash memory card, typically comprising a Secure Digital (SD) format memory card housed in what is otherwise a regular USB flash drive. Secure Digital (SD) is a flash (i.e. non-volatile) memory card format primarily developed for use in portable devices. Today it is widely used in digital cameras, handheld computers, PDAs, mobile phones, GPS receivers, and video game consoles. Standard SD card capacities range from 8 MB to 4 GB, and for newer high capacity SDHC cards the typical range is 4 GB to 32 GB.

Typically, portable electronic devices support a single SD card whilst laptops and personal computers support multiple USB ports, allowing multiple USB flash drives to be connected simultaneously. Accordingly, portable electronic devices provide only limited memory whilst laptop and personal computers support increased memory capacity. However, both have limited memory access speeds and offer no provision for protected back-up capabilities of data stored within the USB flash drives.

It would be beneficial to provide a system and method that overcomes at least some of the above-mentioned limitations.

### SUMMARY OF THE INVENTION

In accordance with an aspect of the invention there is provided a method, comprising: providing a plurality of memory devices, each memory device comprising flash memory, at least one of the memory device and an interface to the memory device supporting a first data transfer rate, A; providing data to the plurality of memory devices, the data provided at a second data transfer rate, B, faster than the data transfer rate, A; dividing the data into N data portions, each of the N data portions for being provided to a different memory device of the plurality of memory devices, wherein B/N≦A; and, storing in parallel each of the data portions within a respective different memory device of the plurality of memory devices.

In accordance with another aspect of the invention there is provided an apparatus, comprising: a data interface for receiving data for storage; a plurality of portable peripheral memory devices, each memory device comprising flash memory, at least one of the memory device and an interface to the memory device supporting a first data transfer rate, A; and, a multiplexer for being coupled to the data interface and for being coupled to the plurality of portable peripheral memory devices, the multiplexer for receiving data from the data interface and for providing the data to the plurality of memory devices at a second data transfer rate, B, which is faster than the first data transfer rate, A, wherein, during use, the multiplexer divides the data received from the data interface into N data portions, each of the N data portions for being provided to a different memory device of the plurality of memory devices at a third data transfer rate, B/N≦A.

In accordance with another aspect of the invention there is provided a method of storing data within a plurality of memory devices, each memory device of the plurality of memory devices comprising flash memory and supporting a first data transfer rate, A, the method comprising: providing data from a data interface to a multiplexer using a second data transfer rate, B, faster than the data transfer rate, A; using the multiplexer, dividing the data into N data portions; providing each one of the N data portions to a different memory device of the plurality of memory devices using a third data transfer rate BIN, wherein B/N≦A; and, storing in parallel each one of the N data portions within a respective different memory device of the plurality of memory devices.

### BRIEF DESCRIPTION OF THE DRAWINGS

Exemplary embodiments of the invention will now be described in conjunction with the following drawings, in which:

FIG. 1A illustrates a prior art multiple memory card access solution;

FIG. 1B illustrates a prior art SD memory card and iNAND memory chip approach with switched access from SD interface circuit;

FIG. 2 illustrates a prior art approach to sharing a single SD interface to multiple SD memory cards;

FIG. 3A illustrates an exemplary embodiment of the invention wherein multiple SD memory cards are multiplexed to provide increased storage data rate;

FIG. 3B illustrates an exemplary process flow for multiplexed high-speed storage of data with subsequent reconciliation of memory;

FIG. 4A illustrates an exemplary embodiment of the invention wherein a portable electronic device employs an array of SD cards for storage and a separate removable SD card to transfer selected data from the portable electronic device;

FIG. 4B illustrates application of the approach of FIG. 4A to audio-visual content acquired with the portable electronic device;

FIG. 5 illustrates application of the approach of FIG. 4A to RAID memory; and,

FIG. 6 illustrates application of the approach of FIG. 4A to cloning a secure USB memory device.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein. In particular, although the various embodiments of the invention are described in the context of using a specific portable memory device format, secure digital (SD) cards, it will be apparent that other formats may be used instead. Some non-limiting examples include compact flash cards, mini SD cards, micro SD cards, memory sticks etc. Generally, a portable peripheral memory device comprising non-volatile, static ram or flash memory may be used with the embodiments of the instant invention.

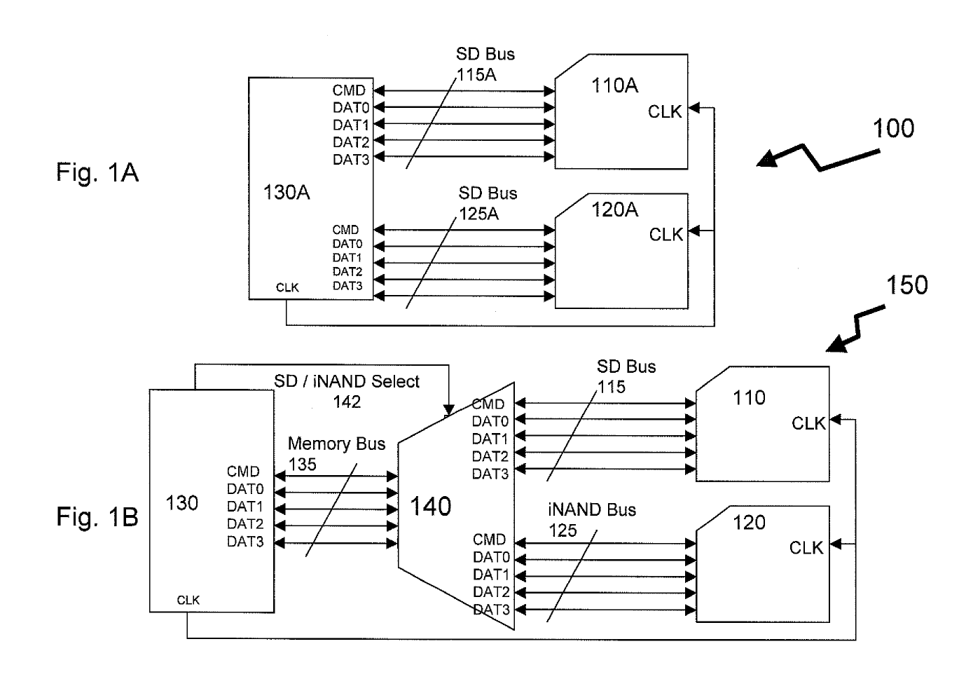

Referring to FIG. 1A, shown is a prior art multiple memory card access circuit 100 comprising a first SD memory card 110A, a second SD memory card 120A, and SD interface 130A. As such, first SD memory card 110A is connected to SD interface 130A by SD bus 115A that comprises CMD, DAT0, DAT1, DAT2 and DAT3 lines. Clocking for the first SD memory card 110A being provided from the SD interface 130A to a clock port on the first SD memory card 110A. Likewise, second SD memory card 120A is electrically interconnected to the SD interface 130A via SD bus 125A that comprises CMD and DAT0-DAT3 lines. Similarly second SD memory card 120A is provided with its clock from the SD interface 130A. Accordingly SD interface 130A simply addresses each of the two SD memory cards 110A and 120A by discrete busses 115A and 125A. As such the SD interface addresses each memory card at the same data rate determined from the clock provided by it to each of the SD memory cards 110A and 120A. Accordingly, the prior art approach does not allow increased data rates, and any applications providing distributed storage, such as backing up stored data, requires an execution at N times the storage to a single memory card, where N is the number of cards to which the data is being backed up. Additionally, the SD interface 130A is a non-standard circuit, even for two SD buses or addressing three or more SD memory cards.

FIG. 1B illustrates a prior art memory access approach with switched access from an interface circuit. As such within memory circuit 150 there is an SD memory card 110, iNAND memory chip 120, SD interface circuit 130 and switch 140. The SD memory card 110 is electrically connected to switch 140 via SD bus 115 comprising CMD, and DAT0-DAT3 data lines. Clocking for the SD memory card 110 is provided from the SD interface circuit 130. Likewise iNAND memory chip 120 is electrically connected to the switch 140 via iNAND bus 125 comprising CMD, and DAT0-DAT3 data lines. Clocking is again provided from SD interface circuit 130. The switch 140 is electrically connected to the SD interface 130 via SD bus 135 comprising CMD and DAT0-DAT3 data lines. The switch 140 also receives a selection signal from the SD interface 130, namely SD/iNAND Select 142, thereby selecting either the SD memory card 110 or iNAND memory chip 120. Memory circuit 150 allows a standard SD interface circuit to be employed with a single SD bus, and the switch 140 is a double single pole quadruple throw (DPQT) switch. However, the overall memory circuit 150 still operates at the clock speed of the memory cards.

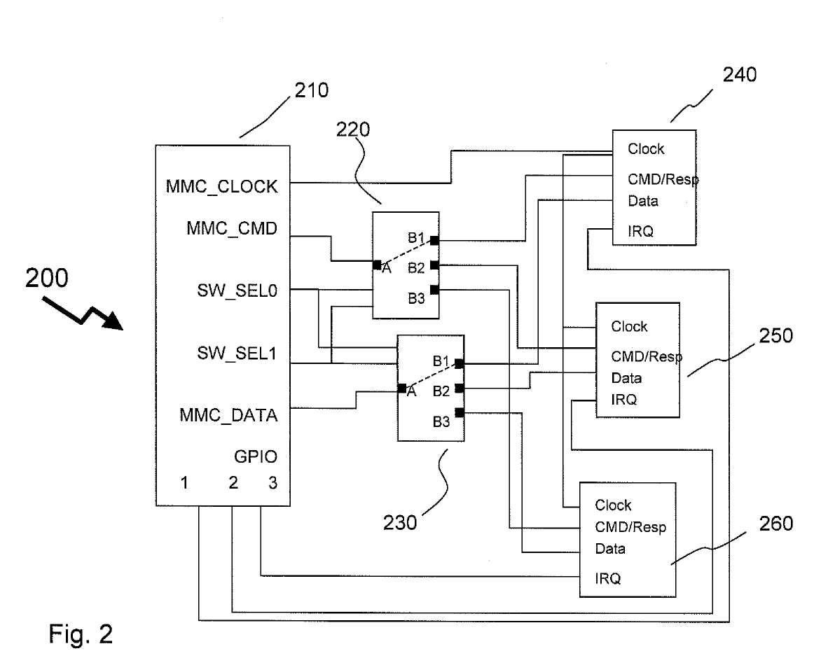

FIG. 2 illustrates another prior art approach to sharing a single SD interface between multiple SD memory cards, as disclosed by Liu et al. in U.S. Pat. No. 7,269,669. Liu et al. teach an SD circuit 200 including a host controller 210 communicating with multiple memory devices, wherein as shown there are three client devices 240, 250, and 260. The host controller 210 being a multimedia controller (MMC) such as Qualcomm® MSM6500 or Intel® PXA250 Microprocessor MMC Controller. Liu et al. further teaches that one or more of the client devices 240, 250, and 260 are part of a portable electronic device such as a PDA, or may reside on an SD card (not shown for clarity). In a preferred embodiment one of the client devices is an SD card slot and SD card containing an SDIO function.

The client devices 240, 250, 260 are interconnected to host controller 210 through switching devices 220 and 230. In the example, with three client devices, the switches are SP3T switches as shown. Also in the example illustrated here, the simultaneous multiple functions are implemented with an I-bit bus for host controller 210. Host controller 210 has one dedicated command signal MMC_CMD, and one dedicated data signal MMC_DATA, which limits this specific configuration to the I-bit bus implementation. The command, MMC_CMD, transmits commands and receives responses from each of the client devices 240, 250, and 260 over data lines that are multiplexed through switches 220 and 230 to the MMC_CMD port on controller 210. Likewise the data signals from all three client devices 240, 250, and 260 are transmitted in sequential time slots through switches 220 and 230 to the MMC_DATA port on controller 210. The time slots for data transmission are synchronized by MMC_CLOCK, which is connected to all three client devices 240, 250, and 260.

The GPIO ports on the controller are configured as interrupts for the three client devices 240, 250, and 260, and connected to the IRQ signal ports, for example via CD and WP contacts on the SD memory card socket, on the three device cards. In operation, the switch selection lines SW_SEL0 and SW_SEL1 select the client devices for connection to the host controller 210 via the switching devices 220 and 230. In the switch configuration shown the MMC_CMD and MMC_DATA ports of the host controller 210 are connected to client device 240. If client device 240 is operating, data is exchanged between client device 240 and the host controller 210. When the data transaction for client device 240 is finished, switching devices 220 and 230 are reset to interconnect client device 250 with the host controller. Data is then exchanged between client device 250 and the host controller 210. Similarly, data is exchanged between client device 260 and the host controller 210. Interrupt signals from the IRQ ports of the client devices indicate which client device is active.

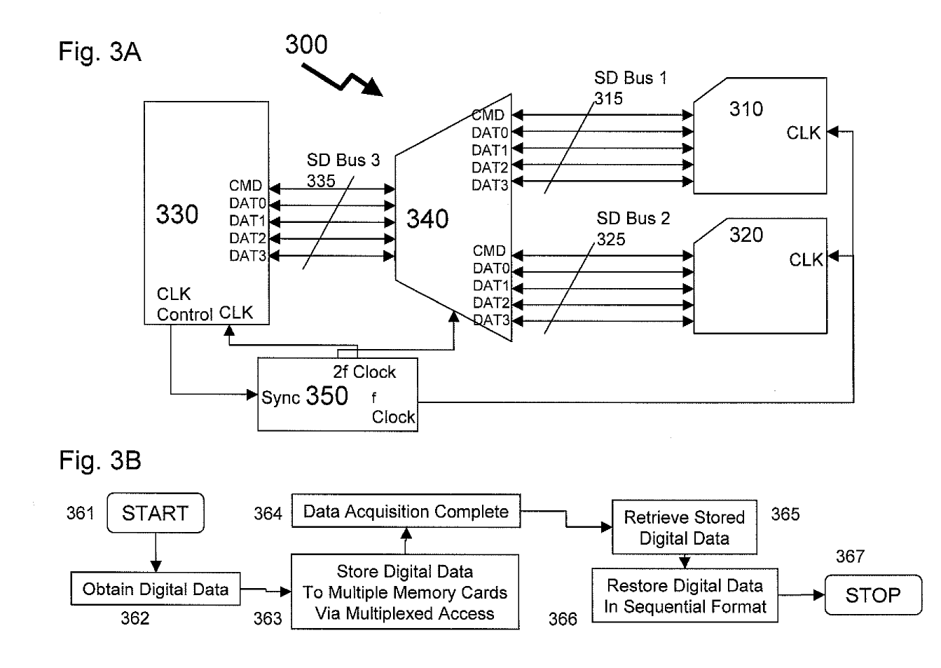

FIG. 3A illustrates an exemplary embodiment of the invention wherein multiple SD memory cards are multiplexed to provide increased storage data rate. As shown, memory card circuit 300 comprises first memory card 310 electrically connected to a multiplexer 340 by SD Bus 1 315 that comprises CMD data line and DAT0-DAT3 data lines. Similarly, second memory card 320 is electrically connected to the multiplexer 340 by SD Bus 2 325. The multiplexer 340 is also electrically connected to SD interface circuit 330 via SD Bus 3 335. The SD interface circuit 330 also provides a clock control signal from an output port CLK Control to a synchronization port of a clock circuit 350. The clock circuit 350 provides a first clock, at frequency f, to clock ports on each of the first and second memory cards 310 and 320. Additionally the clock circuit 350 provides a second clock, at frequency 2 f, to each of the multiplexer 340 and SD interface circuit 330.

In operation, for example when writing data from the SD interface circuit 330 to the first and second memory cards 310 and 320, respectively, the multiplexer 340 receives a first set of data from the SD interface circuit 330 and switches this data from SD Bus 3 335 to SD Bus 1 315 whereupon the data is stored within the first memory card 310. Now, as the multiplexer 340 and SD interface circuit 330 are operating at the second clock of frequency 2 f a second set of data can be clocked from the SD interface circuit 330 and switched to the SD Bus 2 325 whereupon it is stored within the second memory card 320. In this manner the multiplexer 340 provides data to each of the first and second memory cards 310 and 320, respectively, for each cycle of the first clock f. According to this embodiment, not only is memory increased by virtue of providing two SD memory cards, but additionally the write/read data access rate is increased. With modifications to the clock circuit 350, SD interface circuit 330, and multiplexer 340 the number of memory cards can be increased further, for example to 4, 8 etc. such that data write/read access from the combined memory is increased approximately four-fold, eight-fold, etc., respectively. Of course other number of SD cards such as 3, 5, 6 . . . are also supportable.

Whilst the clock frequencies described above with reference to memory card circuit 300 and below with reference to other embodiments are at frequencies of f and N*f, where N is an integer equal to the number of memory cards, optionally the clock frequencies are described as f and M*f where M is not an integer or is an integer that is not equal to the number of memory cards. In general, the multiplexer operates at a rate that is faster than the rate at which the individual cards are operating. Hence if the memory device or the interface to the memory device supports a first data transfer rate of A, and the demultiplexer routes the data as N data portions to N memory devices, then the transfer rate of the data to the multiplexer is supported at a second data transfer rate B, faster than the first data rate A, wherein B/N≦A.

Data transfer rates are measurable in data units/time. As such, a faster data rate results in a higher ratio of units of data per unit of time. A slower data rate would have fewer units of data transferred per same unit of time.

Alternatively the multiplexer operates at a rate faster than N*f, where N is the number of memory cards, such that the data is initially written to a buffer in burst mode and subsequently transferred to the N memory cards having an internal clock rate that is faster than the frequency f of the data bus interfaces to each card.

The multiplexed storage of data, as described above with reference to the memory card circuit 300 of FIG. 3A, presents some potential issues for the subsequent removal of the SD memory cards and extraction of the data that is stored therein, where the device to which SD memory cards are subsequently connected does not support multiplexed write/read access. Accordingly, FIG. 3B illustrates an exemplary process flow for multiplexed high speed storage of data, within an electronic device, and subsequent reconciliation of the data within the memory cards. At 361 the process starts and moves to 362 wherein acquiring the digital data begins, for example video data is captured using a digital camcorder. As the digital data is captured it is stored to multiple memory cards via multiplexed access at 363, thereby allowing an increased write data rate compared to the prior art approaches using same memory cards. Upon completion of the digital data acquisition at 364, the process moves forward to 365 and the electronic device retrieves the acquired digital data and at 366 restores the data in continuous sequential manner within one or more of the memory cards according to the amount of data stored and according to the storage available. The process stops at 367.

Restoring of the data in a continuous manner within a memory card optionally is undertaken before presenting the data back to the user or after review by the user. Optionally the data stored is limited to the capacity of one memory card, which is removable from the electronic device, the other memory being contained within the electronic device, or the electronic device allows the removal of multiple SD memory cards. Alternatively, in other embodiments of the invention the stored data remains in the format distributed across multiple cards when these are removed and inserted into another device supporting multiplexed read access or a device supporting data reconstruction from multiplexed write access memory cards.

Optionally the reshuffling of the data as outlined supra in respect of FIG. 3B is performed automatically during times that the electronic device is idle. For example, when data acquisition stops, the data is automatically shuffled between the memory cards and configured in a format for being transferred to another device that does not support multiplexed read/write access. This automatic process for example is coordinated by the multiplexer, by a processor of one memory card designated as a master whilst the others memory card(s) act(s) as slave devices, or by the processors of multiple memory cards acting in conjunction with each other.

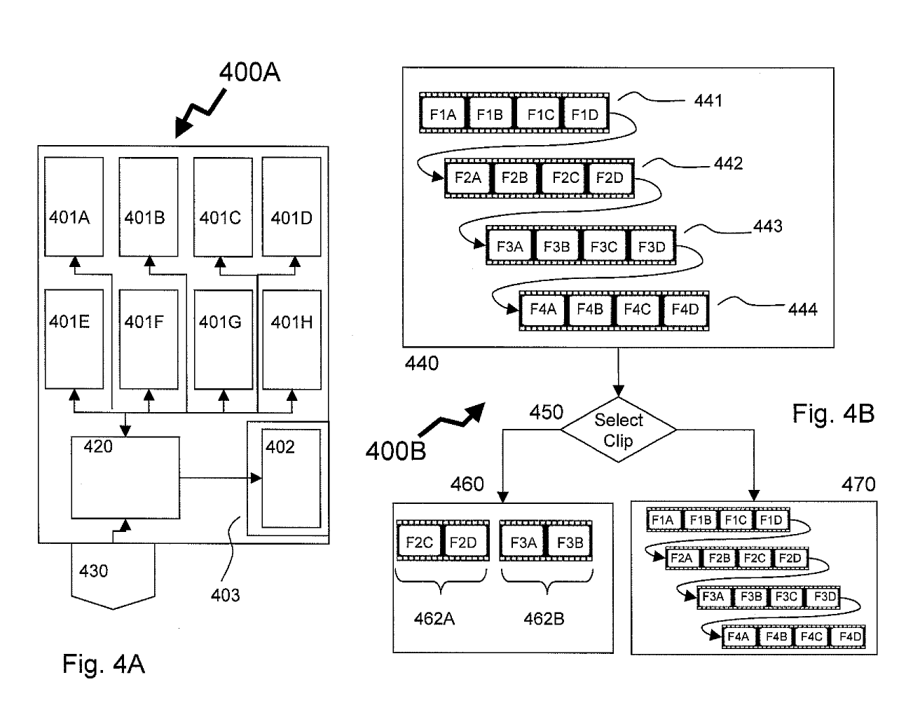

FIG. 4A illustrates an embodiment of the invention wherein a portable electronic device 400A employs an array of SD cards for storage and a separate removable SD card for transferring selected data from the portable electronic device. As shown, the portable electronic device 400A comprises a camera 430 interfaced to a controller circuit 420. The electronic device comprises eight internal memory cards 401A through 401H that are interfaced to the controller circuit 420, such as by an SD interface circuit and multiplexer as described supra in respect of FIG. 3A. Also interfaced to the controller circuit is removable SD memory card 402 that is housed within an SD interface socket 403. Accordingly the camera 430 captures and stores data at up to eight times the data rate of a prior art electronic device employing a single a removable SD memory card.

An application of the portable electronic device 400A is depicted within video flow 400B of FIG. 4B. As shown, a user operating the portable electronic device 400A takes video footage comprising four video shots 441 through 444, which are stored at high acquisition rate into the eight internal memory cards 401A through 401H. Each of the four video shots 441 through 444 comprising four segments FxA through FxD.

After acquisition of the four video shots 441 through 444 the user is prompted to select a clip via a prompt 450. According to an embodiment wherein the removable SD memory card 402 is of lower capacity than the sum of the internal memory cards 401A through 401H then the prompt optionally includes an indication of the amount of reduction required. Such an example is shown when the user is guided through selection process and results in selected video 460, wherein the 16 segments stored, four for each video shot 441 through 444 must be reduced to four. The user thereby selects video content 460 comprising first filtered video shot 462A comprising segments F2C and F2D, and second filtered video shot 462B comprising segments F3A and F3B.

However, if the capacity of the removable SD memory card 402 is sufficient for the stored video or matches the sum of the internal memory cards 401A through 401H when at high usage, then the user optionally stores the full video content as shown in full video transfer 470. During generation of either video content 460 or full video transfer 470 the demultiplexed data stored within the internal memory cards 401A through 401H is retrieved, reconstructed, and sequentially stored within the removable SD memory card 402. Accordingly, lower capacity memory cards are usable for internal storage, albeit with high write speeds, and a single high capacity removable SD memory card is then used for transferring the stored data. By way of a specific and non-limiting example, the internal memory cards 401A through 40111 are low cost 1 GB cards and the removable SD memory card 402 is a 4 GB or 8 GB module. Optionally, transfer of data from the multiplexed memory cards to the higher capacity memory card is performed while the video capture device is idle such that the higher capacity memory card having the data stored thereon in an undivided fashion is accessible to the user most of the time without waiting.

Within the embodiments presented supra the stored data is transferred from the device within which it is generated/acquired to another device via the removable SD memory card. In other embodiments of the invention the electronic device additionally supports direct transfer from the device to another electronic device by way of a communications port. As such, a low capacity removable SD memory card may be employed at low cost for transferring a portion of the data stored within the internal memory cards and the communications port to transfer the full contents thereby avoiding multiple expensive large capacity memory cards.

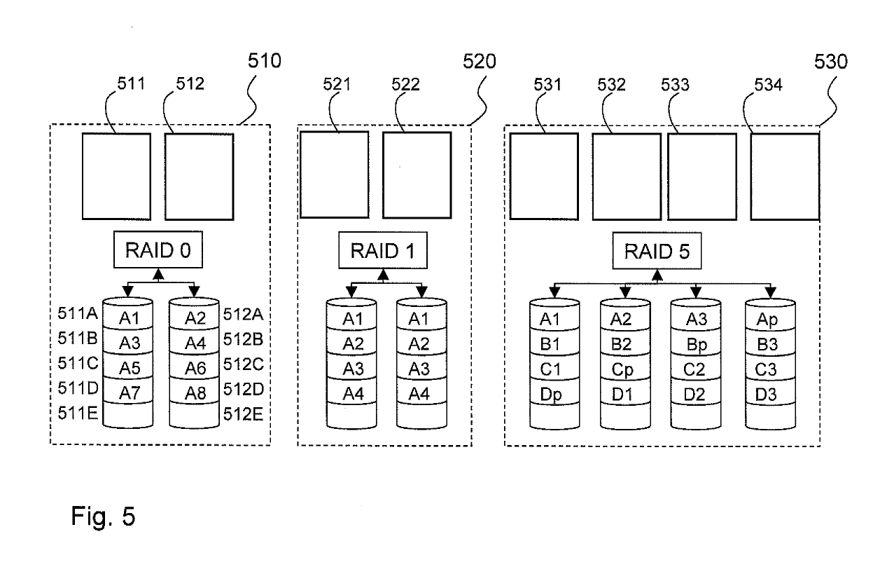

Referring to FIG. 5 illustrated is an embodiment wherein multiple SD memory cards within an electronic device implement RAID memory. As shown, a first RAID 510 comprises two SD memory cards 511 and 512, the RAID 0 configuration being a striped set without parity (i.e. a non-redundant array). As such the first RAID 510 provides improved performance and additional storage but no fault tolerance. As shown, first SD memory card 511 has four written sectors A1 511A, A3 511B, A5 511C, and A7 511D together with unused space 511E. The second SD memory card 512 similarly has four written sectors A2 512A, A4 512B, A6 512C, and A8 512D together with unwritten space 512E. Any memory failure destroys the array, which becomes more likely with more memory cards in the array, because the data is broken into fragments, namely A1 through A8. The number of fragments is dictated by the number of memory cards. The fragments are written to their respective memory cards. This allows smaller sections of the entire chunk of data to be read off memory cards in parallel, giving this type of arrangement increased bandwidth.

Second RAID 520 again comprises two SD memory cards 521 and 522. Similarly with the RAID 0 defined with first RAID 510, the data is stored across the two elements of the array such that first SD memory card 521 comprises written sectors A1 521A, A2 521B, A3 521C, and A4 521D together with unwritten space 521E, whilst second SD memory card 522 comprises written sectors A1 522A, A2 522B, A3 522C, A4 522D and unwritten space 522E. Second RAID 520 acts as a mirrored set without parity. Accordingly the second RAID 520 provides fault tolerance from memory errors and failure of all but one of the memory card but does not increase memory capacity beyond the limit of a single SD memory card.

Also shown is third RAID 530 comprising four SD memory cards 531 through 534. The third RAID 530 is configured to operate as a striped set with distributed parity, wherein all memory cards but one need to be present to operate, a memory card failure requires replacement but the array is not destroyed by a single memory card failure. Upon memory card failure, any subsequent reads are calculable from the distributed parity such that the memory failure is masked from the end user. The array will have data loss in the event of a second memory card failure and is vulnerable until the data that was on the failed memory card is rebuilt onto a replacement memory card. Accordingly a multiplexed configuration such as the eight internal memory cards of portable electronic device 400 of FIG. 4A is configurable as a single RAID 5 with the data for a file distributed across all eight cards with each housing some of parity checks, or two discrete RAID 5 drives. Of course, the setup of the memory cards as a RAID 5 is also advantageous because it provides for easy duplication wherein memory cards are removed and replaced with blank memory cards one after another with a long enough interlude therebetween to allow for rebuild of the information within each new memory card. Thus, for the eight memory cards, once the eight has been replaced, the RAID comprises all of the data of the eight original memory cards while the eight original memory cards also comprise same data.

The above embodiments allow multiplexed SD memory cards or other memory cards to implement high speed RAID devices for enhanced protection of stored data against failures of the memory cards. Such high speed protected memory providing enhancements to a variety of memory based products including portable electronic devices and USB flash drives. Enhanced reliability being important in many secure applications for USB flash drives where the data is stored in encrypted form and not available externally to the USB flash drive. Alternatively, the implementation of high speed RAID devices can be further extended to other RAID devices such as RAID 6 for example, wherein a RAID 5 is extended by adding an additional parity block, thus it uses block-level striping with two parity blocks distributed across all member disks.

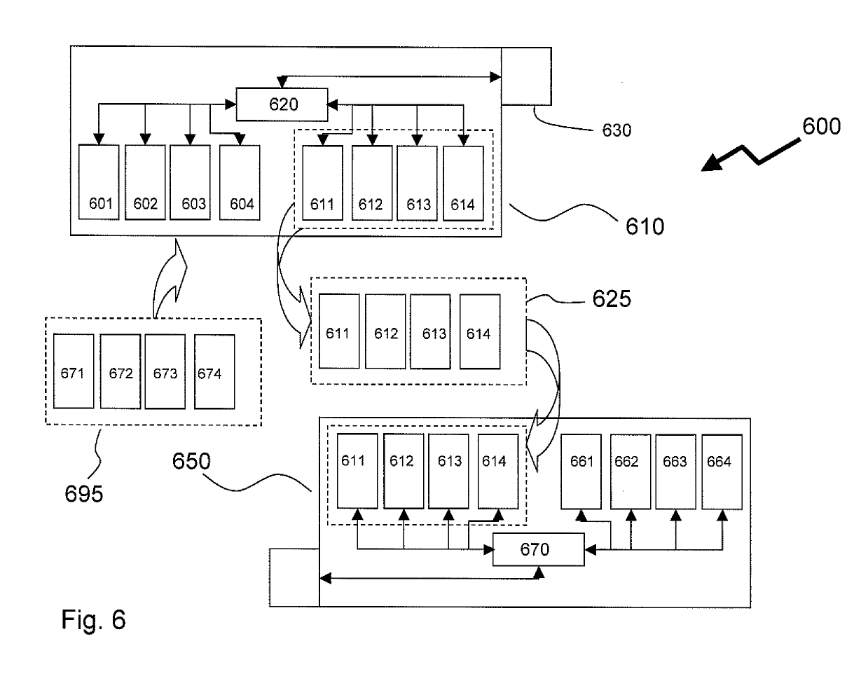

Alternatively the high speed multiplexer in conjunction with RAID configurations allows for cloning of secure USB memory devices. Such an approach is shown within cloning sequence 600 of FIG. 6. As shown a secure USB memory device 610 comprising USB plug 630 and processor 620 contains two groups of memory circuits, the first group comprising memory circuits 601 through 604 which are fixedly mounted within the USB memory device 610, and the second group comprising memory circuits 611 through 614 which are demountably attached in mounting sockets (not shown for clarity). Transfer of data to the secure USB memory device 600 is made via the USB plug 630 from another device (not shown for clarity) which comprises a USB socket into which USB plug 630 is inserted. The data upon receipt by the secure USB memory device is processed by the processor 620 which supports multiplexed memory circuit access such that the data is read to both the first and second groups of memory circuits. Further, each of the first group of memory devices 601 through 604 and second group of memory devices 611 through 614 each act as a RAID 5 array.

When the secure USB memory device 600 is to be cloned, the secure USB memory device 600 is accessed by an authorised user who unlocks the housing (not shown for clarity) that normally covers the second group of memory circuits 611 through 614. In order to clone the secure USB memory device 600 the authorised user will have previously issued to the processor 620 an authorisation command to remove a tamper proofing mechanism within the secure USB memory storage device 600. The tamper proofing mechanism is, for example, one where opening of any portion of the cover of the secure USB memory device 600 results in a wiping of data from all memory circuits, namely first group of memory devices 601 through 604 and second ground of memory circuits 611 through 614. Hence, high speed multiplexed accessing of multiple drives supports the ability to wipe N devices in the same time as one, thereby enhancing security for such high capacity drives when tampering occurs. The second group of memory circuits 611 through 614 are then removed as transfer group 625, and inserted to clone USB memory device 650.

The clone USB memory device 650 comprises processor 670 and a third group of memory circuits 661 through 664, which are fixedly mounted within the clone USB memory device 650. The second group of memory circuits 611 through 614 are demountably attached in mounting sockets (not shown for clarity). The processor 670 of the clone USB memory device 650 upon detecting the insertion of the second group of memory circuits 611 through 614 proceeds to replicate the data within this second group of memory circuits 611 through 614 to the third group of memory circuits 661 through 664, thereby backing up the information stored upon the second group of memory circuits 611 through 614.

Similarly, processor 620 of the secure USB memory device 600 upon detecting insertion of the blank fourth group 695 of memory circuits 671 through 674 duplicates the data from the first group of memory circuits 601 through 604 to the fourth group of memory circuits 671 through 674. Replacement of the housings and provision of correct authorisation to each of the secure USB memory device 600 and clone USB memory device 650 re-establishes the tamper proofing functionality for each device.

Numerous other embodiments may be envisaged without departing from the scope of the invention.

What is claimed is:

1. A method, comprising:
providing a plurality of portable peripheral memory devices, each memory device comprising flash memory, at least one of the memory devices and an interface to the memory devices supporting a first data transfer rate, A;
providing data to the plurality of memory devices, the data provided at a second data transfer rate, B, faster than the data transfer rate, A;
dividing the data into N data portions, each of the N data portions for being provided to a different memory device of the plurality of memory devices, wherein B/N≦A; and,
storing in parallel each of the data portions within a respective different memory device of the plurality of memory devices.

2. A method according to claim 1, wherein at least one of the plurality of portable peripheral memory devices is selected from the group consisting of: a secure digital memory (SD) card; a mini SD card; a micro SD card; a secure digital high capacity memory (SDHC) card; and an iNAND flash memory.

3. A method according to claim 1, comprising:
retrieving the N data portions from storage within the plurality of memory devices;
combining the retrieved N data portions to re-form the data; and,
storing the data on a separate memory device that is removably coupled with the plurality of memory devices.

4. A method according to claim 1, comprising:
retrieving in a predetermined order the N data portions from storage within the plurality of memory devices; and
communicating the retrieved N data portions to an electronic device.

5. A method according to claim 1, comprising:
retrieving in a predetermined order the N data portions from storage within the plurality of memory devices, the N data portions relating to a same data file; and
storing a data file comprising the retrieved N data portions within one of the plurality of memory devices.

6. A method according to claim 1, wherein providing data comprises providing digital data and parity check data relating to the digital data.

7. A method according to claim 6 wherein, the parity check data is stored within one memory device of the plurality of memory devices and the digital data is stored within other memory devices of the plurality of memory devices.

8. A method according to claim 7, wherein the plurality of memory devices operate as at least one of a RAID 3 array, a RAID 4 array, a RAID 5 array and a RAID 6 array.

9. A method according to claim 1, wherein the plurality of memory devices are configured as two memory arrays, each memory array comprising half of the plurality of memory devices, and the digital data is stored twice, once within each memory array.

10. A method according to claim 9, comprising;
transferring one memory array to another electronic device thereby cloning an original electronic device comprising the two memory arrays.

11. An apparatus, comprising:
a data interface for receiving data for storage;
a plurality of portable peripheral memory devices, each memory device comprising flash memory, at least one of the memory device and an interface to the memory device supporting a first data transfer rate, A; and,
a multiplexer for being coupled to the data interface and for being coupled to the plurality of portable peripheral memory devices, the multiplexer for receiving data from the data interface and for providing the data to the plurality of memory devices at a second data transfer rate, B, which is faster than the first data transfer rate, A, wherein, during use, the multiplexer divides the data received from the data interface into N data portions, each of the N data portions for being provided to a different memory device of the plurality of memory devices at a third data transfer rate, B/N≦A.

12. An apparatus according to claim 11, comprising:
a clock circuit, the clock circuit for receiving a first clock signal supporting the data rate, B, and for generating a second clock signal supporting the data rate, A, and for providing the second clock signal to at least one of the portable peripheral memory devices.

13. An apparatus according to claim 11, wherein each of the plurality of memory devices comprises non-volatile random access memory (RAM).

14. An apparatus according to claim 11, wherein at least one of the plurality of memory devices is selected from the group consisting of: a secure digital memory (SD) card; a mini SD card; a micro SD card; a secure digital high capacity memory (SDHC) card; an iNAND flash memory; and, a demountable non-volatile memory.

15. An apparatus according to claim 11, wherein the received data comprises digital data and parity check data relating to the digital data.

16. A method according to claim 15, wherein the parity check data is stored within one memory device of the plurality of memory devices and the digital data is stored within the remaining memory devices of the plurality of memory devices.

17. A method of storing data within a plurality of memory devices, each memory device of the plurality of memory devices comprising flash memory and supporting a first data transfer rate, A, the method comprising:
providing data from a data interface to a multiplexer using a second data transfer rate, B, faster than the data transfer rate, A;
using the multiplexer, dividing the data into N data portions;
providing each one of the N data portions to a different memory device of the plurality of memory devices using a third data transfer rate BIN, wherein B/N≦A; and,
storing in parallel each one of the N data portions within a respective different memory device of the plurality of memory devices.

18. A method according to claim 17, wherein each of the plurality of memory devices comprises non-volatile random access memory (RAM).

19. A method according to claim 17, wherein at least one of the plurality of memory devices is selected from the group consisting of: a secure digital memory (SD) card; a mini SD card; a micro SD card; a secure digital high capacity memory (SDHC) card; an iNAND flash memory; and, a demountable non-volatile memory.
